(19) United States
(12) Patent Application Publication
(10) Pub. No.: US 2002/0002207 A1
(43) Pub. Date: Jan. 3, 2002

(54) Underquarternized anion exchange resins as molecular scavengers

(76) Inventor: Steven L. Regen, Allentown, PA (US)

Correspondence Address: George M. Yahwak, Yahwak & Associates, 25 Skytop Drive, Trumbull, CT, 06611, US

(21) Appl. No.: 09/771,367

(22) Filed: Jan. 26, 2001

Related U.S. Application Data
(60) Provisional application No. 60/178,103, filed on Jan. 26, 2000.

(51) Int. Cl. C08J 5/20; C08F 2/00; C02F 1/42

(52) U.S. Cl. 521/32; 210/683

(57) ABSTRACT

There is described a group of underquarternized anion exchange resins having the ability to bind with and remove from one environment to another a significant fraction of scavenged molecules by forming covalent bonds with the molecules. The method of using such underquarternized resins is also described.

The invention described herein was first-filed in the United States Patent and Trademark Office on Jan. 26th 2000 as United States Provisional Patent Application 60/178103.

Since the early-1980's there has been a nation-wide scrutiny within the medical community to study the role of cholesterol in coronary heart disease (CHD). One factor remaining certain from this scrutiny is that a high level of cholesterol in the bloodstream is one of the major factors, along with smoking and high blood pressure, contributing to CHD, the nation's leading cause of death.

Given the evidence that high-fat, high cholesterol diets contribute to elevated levels of blood cholesterol, and that high blood cholesterol is a definite risk factor for CHD, it is natural to assume that lowering blood cholesterol, by diet or medication, would reduce the risk of CHD. Over the past decades, the evidence collected from a number of studies now points toward the conclusion that lowering blood cholesterol does have an impact on the process of plaque buildup in blood vessels; at the very least, it is clear that people who are at risk of CHD can benefit from lowering their blood cholesterol through diet and, if necessary, the use of cholesterol-controlling drugs.

One fairly large family of cholesterol-controlling drugs is cholestyramine. This drug is sold as a powdered resin under the name of Questran™, and must be hydrated prior to use. The members of this family are resins that bind to bile acids in the intestine thereby interrupting enterohepatic circulation and increasing fecal excretion. These mechanisms result in increasing hepatic bile acid production of hepatic LDL receptors, which increases uptake of LDL from blood and lowers plasma LDL, i.e., lowers blood cholesterol, normally between ten and twenty-five percent. However, while this family of resins has the ability to lower blood cholesterol in persons ingesting the resin, the resins still have unpleasant side effects, and thus there is an ongoing need for improved resins that will act to bind and remove cholesterol from patients suffering from high cholesterol levels in their systems.

It was the result in seeking families of other resins that would have equivalent functions when compared to cholestyramine that the new underquarternized anion exchange resins (that is, resins derived from chloromethylated polystyrene having residual chloromethyl groups along the polymer backbone) described herein were prepared and characterized.

A more thorough understanding of the present invention will be readily apparent and appreciated by the reader in view of the following detailed description of the present invention and the examples provided herein.

Anion-exchange resins are widely used to remove acidic molecules from solution. In the era of organic synthesis, for example, such resins provide a convenient means for ‘scavenging’ excess reagents and byproducts; a feature that has recently been exploited in the solution-phase synthesis of chemical libraries. Anion-exchange resins are also of considerable interest as scavengers in the area of environmental science and medicinal chemistry, e.g., in removing organic contaminants from water, and bile acids from the intestines [see, for example, Environ. Sci. Technol. 32:3756 (1998); and Biochim. Biophys. Acta 210:255 (1998)]. While the reversibility of ion-exchange processes is generally regarded as an attractive feature, such ability can represent a significant limitation for molecular scavenging purposes.

The present invention describes how underquaternized anion-exchange resins (or polymers) (i.e., resins derived from chloromethylated polystyrene, having residual chloromethyl groups along the polymer backbone) can eliminate the ability of a significant fraction of scavenged molecules by forming covalent bonds. To the best of my knowledge, there exists no prior description of this approach to limit desorption from an ion-exchange resin.

The following scheme illustrates the general concept described herein.

[chemical structure]

More specifically, the use of partially quaternized, chloromethylated polystyrene as a covalent scavenger of cholate ion in aqueous media is described herein. The ability of such polymers to scavenge organic anions by covalent as well as by ionic means has important implications in the areas of medicinal and environmental chemistry.

[chemical structure]

In essence, it hypothesizes that the pendant quaternary ammonium groups of an underquaternized anion-exchange resin would concentrate organic anions and assist the nucleophilic displacement at the chloromethyl sites [as, for example, see Phase Transfer Catalysis, Academic Press, (New York) pp 13-56 (1978); or for other examples of intraresin nucleophilic displacement see J. Am. Chem. Soc. 103:5248 (1981)]. At the same time, these ammonium groups would allow for swelling in aqueous media, thereby making the chloromethyl groups accessible.

To test this hypothesis, the ability of five resins (Resins 1-5), bearing mono- or bis-quaternary ammonium pendant groups, to capture cholic acid via covalent as well as ionic bonds was examined. These five resins are structurally depicted as:

[chemical structure]

in which each resin is a cross-linked polystyrene having the following mole fractions:

| Resin | x | y | z | R |
|---|---|---|---|---|
| 1 | 0.74 | 0.21 | 0.05 | R₁ |
| 2 | 0.50 | 0.45 | 0.05 | R₁ |
| 3 | 0.30 | 0.65 | 0.05 | R₁ |
| 4 | 0.81 | 0.14 | 0.05 | R₂ |
| 5 | 0.58 | 0.37 | 0.05 | R₂ |

wherein R1 is CH₂CHOHCH₂OH; and

wherein R2 is CH₂CH₂CH₂N(CH₃)₃Cl

The purpose of the hydroxyl groups in Resins 1-3 was to improve their swelling behavior in water; bis-quaternary ammonium groups were also expected to enhance resin swelling. Cholic acid was chosen as a prototype for scavenging, since it is known that the efficiency of commercial anion-exchange resins in promoting the excretion bile acids in vivo is very low, i.e., less than 2% of the exchangeable sites in Dowex 1-X2 (Cholestyramine) remain populated. In addition, it is currently believed that this low efficiency is a direct consequence of the lability of the captured bile acid with respect to ionic desorption [see Macromolecules 31:5542 (1998)].

### EXAMPLE 1

### General Methodology

Using standard synthetic procedures, 1.5% cross-linked polystyrene was choloromethylated, and subsequently quaternized with limited quantities of 3-(dimethylamino)-1,2-propanediol or 3-N,N-(dimethylamino)-1-propyl-N′,N′,N′-trimethylammonium chloride to give the requisite polymers. A 50.0 mg sample of each polymer was then suspended in 10.0 ml of aqueous solution that was 15 mM in cholic acid 150 mM in NaCl, and 10 mM in phosphate buffer (pH 7). Each suspension was agitated by use of a wrist-action shaker at 23° C., and the extent of scavenging of cholic acid analyzed, polarimetrically, as a function of time. Upon testing it was found that increased levels of quaternization, on going from Resin 1 to Resin 2 to Resin 3 resulted in increased scavenging efficiency; similar results were also found for Resins 4 and 5.

To confirm that covalent attachment contributes to the scavenging of cholate ion, each resin was rinsed, sequentially, with 50 ml of saturated NaCl solution and 50 ml of water to remove ionically bound sterol. After drying (23° C., 24 h, 0.01 Torr), examination of the polymers by IR (KBr pellet) showed increasing levels of ester formation, on going from Resin 1 to Resin 2 to Resin 3, as judged by relative band intensities of the ester carbonyl (1726 cm⁻¹), the aromatic (1601 cm⁻¹), and the chloromethyl (1263 cm⁻¹) groups. Similarly, the intensity of the ester band in Resin 5 was greater than that in Resin 4

A quantitative analysis of the extent of covalent attachment of cholic acid to Resin 3 was made by subjecting the resin to saponification. Thus, a 54.3 mg sample (which was washed with saturated sodium chloride in order to remove ionically bound was suspended in an aqueous solution that was 0.5 M in NaOH and 2.85 M in NaCl. After 75 h of shaking at 23° C., 0.022 mmol of the sterol was released into the aqueous phase. This quantity of cholic acid corresponds to ca. 12° ring substitution, i.e., 12° of the phenyl groups along the polymer backbone contain the cholate ester. Extending the saponification time to 315 h did not lead to any further release of cholate. Extensive rinsing with deionized water, drying (23° C., 24 h, 0.01 Torr), and examination by IR showed the complete loss of the ester carbonyl band. Based on the total amount of cholic acid that was scavenged by Resin 3, and the quantity of sterol that was covalently attached, the contribution from ionic scavenging is estimated to be ca. 38° ring substitution.

Similar experiments carried out with Resins 1, 2, 4, and 5 gave scavenging results that are summarized in the following table:

| polymer | swelling^{a} (%) | mmol/g^{b} | prs^{c} | ionic binding (mmol/g^{d}) |
|---|---|---|---|---|
| 1 | 6 | not determined | | 0.14 |
| 2 | 21 | 0.30 | 7 | 0.72 |
| 3 | 55 | 0.41 | 12 | 1.65 |
| 4 | 25 | 0.13 | 2.6 | 0.53 |
| 5 | 44 | 0.27 | 4.2 | 1.20 |

^{a}percent increase in resin volume relative to the dry state, in the presence of 150 mM NaCl plus 10 mM phosphate buffer (pH 7), estimated by changes in height within a capillary tube;
^{b}millimoles of covalently bound cholate per gram of starting polymer;
^{c}percentage of phenyl rings bearing covalently bound cholate; and
^{d}millimoles of ionically bound cholate per gram of starting material.

As it is not known whether cholate is randomly distributed among the pendant ammonium groups in polymers 4 and 5, ionic binding is presented in terms of millimoles of cholate that was ionically bound per gram of starting polymer. For both series of resins investigated, a higher degree of quaternization resulted in a higher degree of scavenging. Such a finding is a likely consequence of greater swelling and greater accessibility to the chloromethyl sites. The fact that a 3-fold increase in the degree of quaternization (on going from Resin 1 to Resin 3) was found to lead to a 15-fold increase in the percentage of scavenging. Such a finding is fully consistent with this interpretation, as it indicates that resin efficiency is not directly proportional to the number of ion exchange sites along the polymer backbone.

To confirm that ion exchange assists the covalent attachment of cholic acid to Resin 3, tests for inhibition were performed using a nonnucleophilic anion that effectively competes in the ion exchange process, i.e., p-toluenesulfonate. Thus, after suspending a 47.2 mg sample of Resin 3 in 9 ml of an aqueous solution that was 150 mM in p-toluenesulfonate, 150 mM in NaCl, and 10 mM in phosphate buffer (pH 7) for 2 h, the polymer's ability to scavenge cholic acid was evaluated. For this purpose, sodium cholate was added to the suspension, which corresponded to 15 mM in the absence of scavenging. Analysis of the aqueous phase as a function of time showed substantially reduced scavenging of the sterol, i.e., only 6% of the available sites (ionic plus covalent) captured cholate ion after 96 h. Examination of this resin by IR, after extensive washing (saturated NaCl and water) and drying (23° C., 24 h, 0.01 Torr) showed negligible ester formation. Thus, p-toluenesulfonate strongly inhibits both ionic- and covalent-scavenging by Resin 3. This finding is fully consistent with a direct connection between the ion exchange and the nucleophilic displacement processes.

Additional experimental procedures for the synthesis of chloromethylated polystyrene and the polymers of the present invention, the scavenging of cholic acid, the saponification of the esterified form of the polymers according to the present invention, the conversion to the corresponding hydroxamic acid, and inhibition studies using p-toluenesulfonate are described in the following examples.

### EXAMPLE II

### Chloromethylated Polystyrene

To a stirred mixture of 4.40 g of cross-linked polystyrene (1.5% divinylbenzene, 18-50 mesh), 11.0 ml of CC1₄, 9.8 ml of ClCH₂OC₂H₅ was added a solution of 2.57 ml of SnCl₄, 14.7 ml ClCH₂OC₂H₅ and 7.3 ml CCl₄, (prepared at 0° C. by adding SnCl₄ both components) over a period of 30 min such that the temperature was maintained at 20-23° C. After stirring the mixture for 24 h at room temperature, the polymer was separated and washed, sequentially, with 100 ml of dioxane/water (1/1, v/v), 100 ml of 1 M HCl/dioxane (1/1,v/v), 100 ml of water, and 400 ml of THF. The polymer was then extracted with THF (Soxhlet) for 24 h, dried (23° C., 48 h, 0.01 Torr). Examination by IR showed the characteristic chloromethyl group appearing at 1263 cm⁻¹. Based on chlorine analysis (22.63%), the extent of chloromethylated is calculated to be 95% ring substitution.

### EXAMPLE III

### Underquaternized Resin 1

To a heterogeneous mixture of 0.304 g of chloromethylated polystyrene (1.5% divinylbenzene, 6.38 mmol Cl/g, 1.95 mmol Cl; 18-50 mesh) and 0.2 ml of anhydrous N,N-dimethylacetamide was added a solution of 0.0469 g (0.393 mmol) of 3-(dimethylamino)-1,2-propanediol in 0.3 ml of anhydrous N,N-dimethylacetamide. The flask was filled with an argon atmosphere, sealed and gently stirred at 70° C. for 100 h. The external solution was then removed by filtration, and the polymer beads washed, sequentially, with 50 ml of THF, acetone, dichloromethane, acetone and THF. Subsequent extraction (Soxhlet) with THF for 24 h, followed by drying (23° C., 72 h, 0.01 Torr) afforded 0.333 g of resin having a chlorine (18.64°) and nitrogen (1.45°) content.

### EXAMPLE IV

### Underquaternized Resin 2

To a heterogeneous mixture of 0.307 g of chloromethylated polystyrene (1.5% divinylbenzene, 6.38 mmol Cl/g, 1.96 mmol Cl; 18-50 mesh) and 0.2 ml of anhydrous N,N-dimethylacetamide was added a solution of 0.117 g (0.982 mmol) of 3-(dimethylamino)-1,2-propanediol in 0.3 ml of anhydrous N,N-dimethylacetamide. The flask was filled with an argon atmosphere, sealed and gently stirred at 70° C. for 100 h. The external solution was then removed by filtration, and the polymer beads washed, sequentially, with 50 ml of THF, acetone, dichloromethane, acetone and THF. Subsequent extraction (Soxhlet) with THF for 24 h, followed by drying (23° C., 72 h, 0.01 Torr) afforded 0.404 g of resin having a chlorine (15.50%) and nitrogen (2.48%) content.

### EXAMPLE V

### Underquaternized Resin 3

To a heterogeneous mixture of 0.304 g of chloromethylated polystyrene (1.5% divinylbenzene, 6.38 mmol Cl/g, 1.95 mmol Cl; 18-50 mesh) and 0.2 ml of anhydrous N,N-dimethylacetamide was added a solution of 0.176 g (1.48 mmol) of 3-(dimethylamino)-1,2-propanediol in 0.3 ml of anhydrous N,N-dimethylacetamide. The flask was filled with an argon atmosphere, sealed and gently stirred at 70° C. for 100 h. The external solution was then removed by filtration, and the polymer beads washed, sequentially, with 50 ml of THF, acetone, dichloromethane, acetone and THF. Subsequent extraction (Soxhlet) with THF for 24 h, followed by drying (23° C., 72 h, 0.01 Torr) afforded 0.454 g of resin having a chlorine (14.42°) and nitrogen (3.79%) content indicating that 65% of the chloromethyl groups were quaternized.

### EXAMPLE VI

### Scavenging of Cholate by Underquaternized Resin 2

A 50 mg sample of 2 was pre-swollen with 5 ml of PBS (10 mM phosphate buffer plus 150 mM NaCl, pH 7.0) in a test tube that was equipped with a screw cap. After 1 h, the external aqueous phase was separated (centrifuge, 1 min), and 10 ml of PBS, which was also 15 mM in sodium cholate, was introduced. The mixture was agitated by use of a wrist-action shaker, and the external aqueous phase analyzed as a function of time. For this purpose, 5 ml of the solution was withdrawn and analyzed, polarimetrically; sodium cholate has a specific rotation of [a]D+31.3° (c=0.5, H₂O). After 170 h, the polymer was transferred to a column (4 mm, i.d.), washed with 50 ml of saturated NaCl (4 h) and 50 ml of water (4 h), and freeze-dried (24 h, 0.01 Torr). A portion of the resin (8 mg) was then analyzed by IR (KBr, 80 mg).

### EXAMPLE VII

### Scavenging of Cholate by Underquatenized Resin 3

A 50 mg sample of 3 was pre-swollen with 5 ml of PBS (10 mM phosphate buffer plus 150 mM NaCl, pH 7.0) in a test tube that was equipped with a screw cap. After 1 h, the external aqueous phase was separated (centrifuge, 1 min), and 10 ml of PBS, which was also 15 mM in sodium cholate, was introduced. The mixture was agitated by use of a wrist-action shaker, and the external aqueous phase analyzed as a function of time. For this purpose, 5 ml of the solution was withdrawn and analyzed, polarimetrically; sodium cholate has a specific rotation of [a]D+31.3° (c=0.5, H₂O). After 170 h, the polymer was transferred to a column (4 mm, i.d.), washed with 50 ml of saturated NaCl (4 h) and 50 ml of water (4 h), and freeze-dried (24 h, 0.01 Torr). A portion of the resin (8 mg) was then analyzed by IR (KBr, 80 mg).

### EXAMPLE VII

### Determination of the Extent of Ester Formation by Underquaternized Resin 2

To 53.0 mg of Resin 2, which had been used to scavenge cholic acid (see above) was added 3 ml of 5.7 M NaCl and 3 ml of 1 M NaOH. The mixture was gently stirred, and the external aqueous phase monitored for the release of sodium cholate by polarimetry. The extent of release reached a constant value after 75 h, which corresponded to 15.8 μmol of the sterol. This corresponds to 0.30 mmol cholate/g of dry resin, or 8° ring substitution. At the end of the saponification, the polymer was transferred to a column (4 mm, i.d.), washed with 50 ml of water, and dried (23° C., 24 h, 0.01 Torr), and its IR spectrum recorded using 8 mg of polymer and 70 mg of KBr.

### EXAMPLE VIII

### Determination of the Extent of Ester Formation by Underquaternized resin 3

To 54.3 mg of Resin 3, which had been used to scavenge cholic acid (see above) was added 3 ml of 5.7 M NaCl and 3 ml of 1 M NaOH. The mixture was gently stirred, and the external aqueous phase monitored for the release of sodium cholate by polarimetry. The extent of release reached a constant value after 75 h, which corresponded to 22 μmol of the sterol. This corresponds to 0.41 mmol cholate/g of dry resin, or 12% ring substitution. At the end of the saponification, the polymer was transferred to a column (4 mm, i.d.), washed with 50 ml of water, and dried (23° C., 24 h, 0.01 Torr), and its IR spectrum recorded using 8 mg of polymer and 70 mg of KBr.

### EXAMPLE IX

### Inhibition of Scavenging by Sodium P-Toluene Sulfonate

A 47.2 mg sample of Resin 3 was added to 9.0 ml of PBS (10 mM phosphate buffer plus 150 mM NaCl, pH 7.0), which contained 150 mM sodium p-toluene sulfonate. After equilibration for 2 h, 1.0 ml of PBS that was also 15 mM in sodium cholate was then added. The uptake of cholate was monitored, polarimetrically, for 96 h.

### EXAMPLE X

### Hydroxamic Acid Formation

To 3.99 mg of Resin 3, which had previously been used to scavenge cholate ion, was added 50 μl of methanol in order to swell the polymer. After swelling for 5 min, 100 μl of 2.0 M NH₃OH in CH₃OH was then added (prepared by addition of 2.0 ml (14 mmol) of 7 M KOH in CH₃OH to 5.0 ml of a stirred solution of 2.8 M NH₂OH HCl in CH₃OH at 10° C. under an argon atmosphere). The reaction mixture was then stirred for 6 h at 60° C., cooled to room temperature, diluted with 200 μl of CH₃OH, and acidified using 200 μl of 1 M HCl. After adding 70 μl of a 200 mM aqueous solution of FeCl₃, the mixture was further diluted by an equivalent volume of CH₃OH for colormetric analysis at 530 nm. Based on the absorbance observed for an analogous reaction of 0.93 mg (1.86 μmol) of benzylcholate with NH₃OH under identical conditions, the ester content in the spent resin is estimated to be 0.390 mmol/g, which corresponds to 11% ring substitution, or 1.53 μmol of ester within the 3.99 mg sample of polymer. Extending the reaction time with benzylcholate or with the polymer-bound analog to 16 h did not alter the absorbance readings.

The use of underquaternized anion-exchange resins as covalent scavengers of a bile acid represents a fundamentally new approach to a problem that has daunted medicinal and polymer chemists for more than four decades. Whether or not such a strategy can lead to improved therapeutic agents by minimizing desorption in vivo will depend on other important factors that remain to be examined; e.g., (i) the effectiveness of intraresin nucleophilic displacement in vivo, and (ii) the stability of sterol-resin, ester bonds with respect to hydrolysis.

In principle, the capture of environmental contaminants using underquaternized anion-exchange resins (especially ones that can be regenerated by chemical means after use) as described above is therefore an attractive concept to the scientific community.

Thus, while I have illustrated and described the preferred embodiment of my invention above, it is to be understood that this invention is capable of variation and modification and I therefore do not wish or intend myself to be limited to the precise terms set forth, but desire to avail myself of such changes and alterations that may be made for adapting the invention to various usages and conditions. Accordingly, such changes and alterations are properly intended to be within the full range of equivalents, and therefore within the purview of the following claims.

Having thus described my invention and the manner and a process of making and using it in such clear, full, concise and exact terms so as to enable any person skilled in the art to which it pertains, or with which it is mostly nearly connected, to make and use the same;

I claim:

1. Underquarternized anion exchange polymers as molecular scavengers.

2. Underquarternized anion exchange resins of the general formula [chemical structure]
wherein x is an integer from 0.25 to 0.85, y in an integer of from 0.10 to 0.70, z is an integer of 0.05, and R is selected from the group consisting of CH₂CHOHCH₂OH and CH₂CH₂CH₂N(CH₃)₃Cl.

3. A method of removing cholic acid and cholic acid derivatives from a liquid environment which comprises contacting said environment with an underquarternized anion exchange resin, and allowing said acid or acid derivative to bind with said resin.
